(19) United States
(12) Patent Application Publication
(10) Pub. No.: US 2026/0357071 A1
(43) Pub. Date: Nov. 12, 2026

(54) METHOD FOR PRODUCING EFFECT PIGMENTS

(71) Applicant: GIESECKE+DEVRIENT CURRENCY TECHNOLOGY GMBH, Munchen (DE)

(72) Inventors: Andreas RAUCH, Gmund am Tegernsee (DE); Markus NICKISCH, Gmund am Tegernsee (DE); Winfried HOFFMULLER, Gmund am Tegernsee (DE); Patrick RENNER, Gmund am Tegernsee (DE)

(21) Appl. No.: 19/490,536

(22) PCT Filed: May 21, 2024
(86) PCT No.: PCT/DE2024/100466

§ 371 Date: Dec. 5, 2025

(30) Foreign Application Priority Data
Jun. 7, 2023 (DE) 10 2023 114 955.5

(51) Int. Cl. C09C 1/00

(52) U.S. Cl. CPC C09C 1/0018; C09C 2220/20

(57) ABSTRACT

A process for creating effect pigments involves providing a donor film with a relief structure. A reflective layer is applied to this relief structure. An acceptor film with an adhesive layer on one side is also prepared. The process forms a first-layer composite by laminating the acceptor film's adhesive layer onto the reflective layer on the donor film's plateau surfaces. When the donor film is peeled away, the reflective layer remains on the lowered regions and flanks as a residual layer, while the acceptor film captures pieces of the reflective layer from the plateau surfaces. These pieces are then detached to form effect pigments, with their shape determined by the relief structure. To facilitate this, the relief structure is pretreated to reduce adhesion, such as by loosening the adhesive or applying a release agent, enabling pigment pieces to detach while maintaining the adhesive layer on the acceptor film.

The invention pertains to a method for producing effect pigments on a foil carrier.

Documents of value are often secured using effect pigments, which allow the authenticity of the data medium to be verified and at the same time increase the anti-counterfeit security.

Effect pigments may for example be integrated in the substrate of the document of value, or applied to the substrate, in the form of an ink, for example.

Methods for producing effect pigments on a foil carrier are known. With methods known to date, the surface of the foil carrier bears a layer which is altered by exposure to solvents-by partial swelling or dissolving, for example. This layer is given a reflective layer as desired for the effect pigments, and the foil carrier is subsequently contacted with the solvent. With mechanical assistance-by brushing and/or winding over an edge-the reflective layer is washed down and fractured in the process. A method of this kind for pigment production leads to irregularly shaped pigments which exhibit a size distribution.

A known way of producing effect pigments of defined size is to use soluble or swellable embossing varnishes. In this case, embossing is used to define areas which after subsequent vapour deposition correspond to the effect pigments. These soluble or swellable embossing varnishes display poor detachment characteristics for the effect pigments, which are consequently easily damaged during detachment. The process window with these embossing varnishes is very small. In the case of complete detachment, moreover, coated intermediate regions may also be detached that do not correspond to the desired geometries. If the effect pigments are processed further to give an effect pigment ink, this ink then has a lower purity.

Additionally known are embossing varnishes which after vapour deposition display only limited metal adhesion. An adhesion promoter layer is applied to these varnishes, before vapour deposition with the reflective layer, to achieve sufficient adhesion. The adhesion promoter layer between reflective layer and embossing varnish hinders the detachment of the effect pigments and causes the contours of the effect pigments to be less clearly defined.

With the known methods for producing effect pigments, the pigments are formed in irregular shape and size. If a printing ink is to be produced in the ongoing process, a fine fraction of effect pigments leads to reduced brilliance of the print, and a coarse fraction of effect pigments leads to disruptions in the printing process. If effect pigments are to be encapsulated, the size scatter of the respective effect pigment in relation to the capsule limits the mobility of the effect pigment.

It is known practice from WO 2019/057321 A 1 to produce effect pigments having a predetermined contour by means of a metal transfer method. Because of the adhesion of the reflective layer on the embossing varnish layer, however, this contour is damaged when the effect pigments break off.

It is an object of the invention, therefore, to generate effect pigments featuring better definition of shape and size.

The invention is defined in Claims 1 and 2. The dependent claims relate to preferred configurations.

A method is envisaged for producing effect pigments, in multiple variants. Common to the variants are the application of a reflective layer and the formation therefrom of pieces which later constitute the effect pigments. The method involves producing a laminate composed of a donor foil and an acceptor foil and separating this laminate again, with the pieces after separation adhering on an adhesive layer of the acceptor foil. Additionally, a surface of the donor foil is given an adhesion-reducing pretreatment before the reflective layer is applied, and the pieces are parted from the acceptor foil not exclusively by mechanical exposure. These features interact to the effect that the laminate can be separated and the pieces detached such that the contour of the pieces and hence of the effect pigments is not impaired. In terms of their contour (outer contour and inner contour), the pieces correspond to the effect pigments. The differences in the variants relate to the manner in which the reflective layer is structured to generate the pieces.

It will be appreciated that all preferred and particularly preferred embodiments described for the first variant are equally valid for the second variant, and vice versa, unless explicitly ruled out for the respective other variant. This is especially the case for the adhesion-reducing treatment options and for the techniques for detaching the pieces from the adhesive layer.

### Variant 1

In the first variant, in a first step, a donor foil is provided. The donor foil is preferably a polymeric foil, such as a PET foil, for example. In a second step, a relief structure is disposed on a facing side or a reverse side of the donor foil. The relief structure is preferably shaped in an embossing varnish layer. It is possible to use embossing varnishes which exhibit limited metal adhesion. The embossing varnish layer may be a radiation-crosslinkable varnish layer, with particular preference a UV-crosslinkable layer. It typically consists of a mixture of prepolymers, reactive diluents, such as, for example, acrylic esters, photoinitiators, preferably alpha-hydroxy ketones and phosphine oxides such as, for example, Omnirad 819, a bisacylphosphine oxide (BAPO), synergists such as, for example, amine synergists, and additives. Reactive diluents of relatively high molecular mass may also be used as prepolymers. An example thereof are polyethoxylated compounds, e.g. TMP(EO)xTA, with x typically being between 3 and 15. The relief structure may also be produced by deposition and subsequent lasering or etching, more particularly photolithography.

The relief structure comprises plateau areas, lowered regions and flanks in between them. It sets the desired pigment geometry, specifically through its configuration. The pigment geometry is set through the shape of the plateau areas of the relief structure. The shape of the plateau areas firstly determines a subsequent outer contour of the effect pigments. Secondly, an inner contour of the effect pigments may also be mandated, with the plateau areas, as a result of a lowered region within the plateau areas, having one or more holes which set an opening/openings in the subsequent effect pigment. Each opening in this case may be configured as a regular polygon, circle, oval, irregular polygon, symbol or text-the same configurations are also possible, of course, for the outer contour. Where the plateau areas form a hexagon, for example, the outer contour of the subsequent effect pigments will also be that of hexagons. Where these hexagons additionally have a lowered circular region in their centre as an inner contour, the subsequent effect pigments will have a circular recess in the centre.

As a result of deliberately different configuration of the plateau areas, effect pigments with different configurations can be generated in a single operation; they are referred to as bimodal or trimodal pigments. It is possible, for example, for the plateau areas to differ in their outer contour, or else to be identical in their outer contour but to differ in their inner contour; they may also be different in outer and inner contour.

Prior to coating, to be carried out in a subsequent step, the relief structure is given an adhesion-reducing pretreatment. There are various ways in which this can be carried out.

If the relief structure is shaped into an embossing varnish having limited metal adhesion, it is important that the limited metal adhesion is reduced further prior to coating. In commonplace methods, after the application of the relief structure, further adhesion-promoting processes are carried out, such as corona or plasma treatments, for example. Corona and plasma treatments are surface treatments which increase surface energy of the embossing varnish layer, with a concomitant improvement in wettability of the embossing varnish layer. With these treatments, moreover, the surface of the embossing varnish layer is free of impurities lacking firm attachment, with a consequent improvement in adhesion likewise. In the simplest case, these adhesion-promoting processes may be deliberately shunned, in order to keep the adhesion of the reflective layer low on the basis of the limited metal adhesion already possessed by the embossing varnish layer in any case.

When the relief structure is shaped in an embossing varnish layer, the surface of the relief structure can be specifically inactivated. Embossing varnishes are generally subjected, after embossing, to a UV curing process, after which the surface is generally active. It is possible to inactivate the surface by adding additives. Deficient strength of adhesion of subsequent layers is considered an indicator of an inactive surface. One way of inactivating the surface is through additives which reduce the surface tension of the embossing varnish, or additives which act as release agents, migrate specifically to the surface of the embossing varnish and thereby reduce the surface tension of the embossing varnish layer. Typical additives for reducing the surface tension of embossing varnishes, particularly of UV varnishes, are silicone surfactants, such as BYK 307 and BYK 333, for example. Surfactants have a construction made up of a hydrophilic part with a high surface energy and a hydrophobic part with a low surface energy. Accordingly, they adopt a disposition (migrate) such that the parts having the low surface energy are located at the surface of the embossing varnish layer, as this is more energetically favourable. Photoinitiators, such as Omnirad 1173, are also initially distributed in the liquid embossing varnish and are less compatible in the cured embossing varnish layer; they do not migrate specifically to the surface of the embossing varnish layer. However, if they have reached the surface of the embossing varnish layer, there is no longer any energetic reason for them to migrate back into the embossing varnish layer. Further possible additives for the embossing varnish layer are alkyl phosphonic acids. Their behaviour is analogous to that of surfactants, but they are additionally capable of particular affinity for metal layers. On the one hand, they are not firmly bound into the embossing varnish layer, but on the other hand they saturate the reflective layer applied to the embossing varnish layer and hence form a kind of release layer. This facilitates the non-firmly adhering application of additional layers in the method. The additives described may be applied for example in highly diluted form as a release layer in a printing process. The release layer is applied over the full area.

It is also possible for the surface of the relief structure to be overprinted with a soluble printing ink, referred to as a washable ink, and inactivated by subsequent washing, during which the washable ink is detached. Washing is accomplished after the application of the soluble printing ink and the physical drying thereof, in a separate operation, albeit before the application of the reflective layer.

The possible pretreatments illustratively identified specifically reduce the adhesion of further layers on the relief structure. A single adhesion-reducing pretreatment may be carried out; alternatively, multiple pretreatments may be combined with one another. For example, after inactivation of the surface of the relief structure, a washable ink may additionally be applied and washed off.

In the following step, a reflective layer is applied to the relief structure and to any adhesion-reducing layer that may be located on it. With particular preference, the reflective layer is applied over the full area. The reflective layer used may be a metal layer, composed for example of aluminium, copper, chromium, iron, nickel, cobalt or silver or of alloys of the aforesaid metals. Possibilities include stainless steel alloys or aluminium alloys, such as, for example, AlMn, AlMg₃, AlMg₅, AlMgMn, AlMgSi, AlSi, and also additions of Fe, Cu, Mn, Cr, Zn or Ti. Through combination with ferromagnetic layers (Fe, Co, Ni), optically variable effects can be generated. The reflective layer is applied generally via physical vapour deposition (PVD). Rather than as a metal layer, the reflective layer may also be embodied as a high-refractive-index layer (HRI layer).

The reflective layer preferably comprises further layers, such as dielectric layers, reflector layers, absorber layers and/or magnetic layers, for example. Possible materials for the dielectric layers are SiO₂, MgF₂, ZnS or TiO₂; the reflector layers consist for example of aluminium or silver; the magnetic layers may consist, for example, of nickel, iron or magnetic alloys; and the absorber layer may be a chromium or aluminium layer, for example. The reflective layer then forms a PVD laminate.

With particular preference, the reflective layer and hence the subsequent effect pigment comprises a three-layer construction, which may be designed as a colour flop construction and/or colour filter construction. A three-layer construction consists preferably of a semi-transparent metal layer, a dielectric and a reflecting or semi-transparent metal layer. In the case of a multilayer reflective layer (PVD laminate), it is critical for the lowermost layer-that is, the layer situated closest to the relief structure-to be adapted to the relief structure or to the adhesion-reducing layer disposed on the relief structure. Where, for example, the lowermost layer is an absorber layer, in an individual case the release force of the relief structure or of the adhesion-reducing layer with respect to chromium might be too high, meaning that a thin aluminium layer or a thin copper layer must be selected as the absorber layer. Moreover, all of the layers of the PVD laminate must be suitable for what is referred to as separative winding. They must not form an unpartable composite with the relief structure, since in the subsequent detachment process all of the layers must be broken in unison.

Thin reflective layers with too low a release force are extremely scratch-sensitive. If the reflective layer is scratched during actual processing, when winding over rolls, for example, or is transferred without further apparent effect onto the rolls or, in a winding, onto the reverse side of the foil, the release force is too low. The release force is too great if, during attempted separative winding, one of the foils involved (donor foil or acceptor foil) tears, the adhesive layer parts from the acceptor foil, the embossing varnish layer parts from the donor foil, or the bond between the adhesive layer and the reflective layer fails. With correct setting of the release force, the method for producing the effect pigments must be able to take place on a web which is conveyed at not less than 10 m/min. The maximum achievable peel adhesion force between adhesive layer and reflective layer is in the region of 5 N/15 mm.

Individually, the layer thicknesses are metal-and effect-dependent. The layer thickness of the metal layers is between 2 nm and 70 nm, preferably between 5 nm and 30 nm. The layer thickness of the dielectric layer in the case for example of SiO 2 is between 100 nm and 600 nm, preferably between 200 nm and 400 nm. Through the physical vapour deposition method, the reflective layer is applied with a uniform layer thickness on a planar face. In the method, however, the reflective layer is applied not to a planar face, but instead to the relief structure formed by the plateau areas, flanks and lowered regions. Because of the application of the reflective layer on the structured relief structure, lower layer thicknesses are deposited at the flanks in the PVD method than on the plateau areas and in the lowered regions. This effect causes thinned-out regions at the flanks, in which the reflective layer is applied more thinly than in the other regions. They form the predetermined breakage points during subsequent separation of the laminate. Predetermined breakage points are of course formed analogously at the flanks of a subsequent inner contour, if an inner contour is provided. To ensure the formation of the predetermined breakage points in the reflective layer, the height of the plateau areas above the lowered regions of the relief structure must be greater than the thickness of the reflective layer only in that case are thinned-out regions of the reflective layer formed at the flanks. The thinned-out regions also come about in the case of other coating methods. In the CVD method, for example, the thinned-out regions come about not at the flanks, but rather at convex bend points in the relief structure. In that case as well, the thinned-out regions constitute predetermined breakage points during subsequent separation of the laminate.

In the subsequent step, an acceptor foil is provided which has an adhesive layer located thereon on one side. The adhesive layer is located on the facing side or the reverse side of the acceptor foil. The potential materials for the acceptor foil correspond to those of the donor foil; the acceptor foil is preferably a polymeric foil. In a laminating step, the adhesive layer is placed onto the reflective layer of the donor foil; the adhesive layer is in contact with the reflective layer exclusively in the plateau areas, and the two layers are laminated to one another. Conversely, the flanks and the lowered regions are not laminated to the adhesive layer. The result is a laminate of donor foil with embossing varnish layer disposed thereon, generally with the adhesion-reducing layer located on said embossing varnish layer, and of acceptor foil with adhesive layer disposed thereon. The effect pigments are preferably produced using a roll-to-roll process. The roll-to-roll process is carried out preferably at a web speed of at least 25 m/min and a roll temperature of 140 °C. The roll diameter is preferably more than 250 mm. One of the rolls in the roll-to-roll process is preferably a steel roll, and the other roll is an impression roll of suitable hardness. An impression roll of medium hardness is preferably selected, e.g. 80 Shore-A. The selection of the hardness of the impression roll allows the height sensitivity of the transfer process to be set.

Subsequent to the laminating step, the donor foil is peeled from the acceptor foil. This is done by applying a vertical tensile force to the laminate-the force acts vertically with respect to the surface of the laminate. Generally speaking, the vertical tensile force is applied in the production process by means of what is called separative winding. There are different arrangements possible for the separative winding. It is advantageous for the separative winding to proceed in a roll-to-roll process, with this roll-to-roll process with particular preference always taking place with the same angular relationships at the peeling point. The acceptor foil may be passed between two rolls and led either by the upper roll or the lower roll. In this case, the separative winding is different according to web tension.

Application of the vertical tensile force parts the laminate generated in the previous step. Because of the adhesion-reducing pretreatment of the relief structure in the embossing varnish layer, the adhesion between adhesive layer and reflective layer on the plateau areas is greater since the adhesive layer is only there in contact with the reflective layer-than between reflective layer and embossing varnish layer/adhesion-reducing layer, meaning that on the plateau areas, the reflective layer is peeled off in the form of pieces from the embossing varnish layer. The reflective layer here is separated off at the thinned-out regions formed beforehand at the flanks of the relief structure, these regions acting as predetermined breakage points, and at the flanks and in the lowered regions of the relief structure, the reflective layer remains on the embossing varnish layer/adhesion-reducing layer. There, the adhesion of the reflective layer on the relief structure is indeed likewise low, owing to the adhesion-reducing pretreatment-the extent of this adhesion is the same as on the plateaus-but the adhesive layer has no contact at all with the flanks or with the lowered regions, and so the adhesion between reflective layer and embossing varnish layer/adhesion-reducing layer is sufficient for the reflective layer to remain on the flanks or the lowered regions on the relief structure. The separation of the reflective layer at the predetermined breakage points ensures clear contours of the effect pigments. Because of the adhesion-reducing pretreatment of the relief structure, damage to the contour during separation is avoided; the relief structure parts from the plateau areas extremely easily. Additionally, the pieces corresponding to the subsequent effect pigments are additionally protected against being crushed, torn or similarly damaged, by the adhesion of the reflective layer to the adhesive layer on the plateau areas. The predetermined breakage points, moreover, ensure contour-precise breaking of the reflective layer. These three aspects in combination ensure particularly high quality of the effect pigments in terms of their shape. The contouring achieved is precise. Furthermore, owing to the adhesion-reducing pretreatment of the relief structure, it is possible to use relatively weak adhesive layers to carry out the method.

Application of the vertical tensile force causes the donor foil to separate from the acceptor foil again. The acceptor foil has the adhesive layer over the full area, and said layer has on it the pieces of the reflective layer which have separated off at the predetermined breakage points and which were disposed on the plateau areas of the relief structure. These pieces of the reflective layer constitute the subsequent effect pigments and after this method step are fixed on the acceptor foil by means of the adhesive layer. They already have their ultimate shape/contour. Over the full area of the donor foil, the relief structure and the adhesion-reducing layer that is generally present remain, and on the flanks and in the lowered regions of the relief structure, those parts of the reflective layer that have not separated off are present as a residual layer. Because of the clear spatial separation of effect pigments and parts of the reflective layer that have not separated off, by the predetermined breakage points formed in the PVD method, contamination with fragments that do not have the desired contours is specifically avoided. The parts of the reflective layer that have not separated off adhere as a residual layer on the donor foil, and the pieces of the reflective layer adhere to the adhesive layer of the acceptor foil.

At the end of the separating step just explained, the pieces are clearly defined in their shape; however, they are still fixed by the adhesive layer to the acceptor foil, meaning that for further processing as effect pigments they must be parted from the acceptor foil in the subsequent step. This is necessary in order to allow the effect pigments to be processed further into, for example, a printing ink in further method steps.

In the further course of the method, therefore, the pieces which form the effect pigments are detached from the acceptor foil by dissolving or loosening the adhesive layer or infiltrating the pieces with a release agent. This causes the pieces to detach from the adhesive layer without being destroyed, broken, torn or similar. Destruction of the contours of the subsequent effect pigments is avoided as a result.

The pieces can therefore be parted from the acceptor foil without brushes or winding over an edge. Treatment with a felt, a washing bar, a wiping lip or the like is then sufficient. With particular preference, the pieces are parted from the acceptor foil without any mechanical assistance. In the majority of application scenarios, the pieces are detached by complete dissolution of the adhesive layer. However, detachment by infiltration of the pieces is also possible, resulting in the acceptor foil continuing to bear the adhesive layer even after the pieces have been detached. The term “infiltration” refers to the penetration by an additive in the form of a release agent into the interface between pieces, which correspond to the subsequent effect pigments, and the adhesive layer. The additive, for example water or a solvent adapted to the adhesive layer, propagates in the interface and reduces the adhesion of the pieces. With particular preference, the adhesion of the pieces to the adhesive layer is reduced to such an extent that it is negated entirely. In the case of infiltration, the adhesive layer is not dissolved. An example of infiltration is the testing of painted panels. When such panels are exposed to weathering, blistering occurs-the paint is infiltrated. Because the acceptor foil is neither brushed nor wound around an edge, the quality of the effect pigments and hence the purity of the resulting pigment ink is increased, since such mechanical detachment damages the contours of the effect pigments.

Water-soluble adhesives can be used for the adhesive layer, such as polyvinylpyrrolidone in various grades (K17, K25, K30), for example. A precondition for the adhesive layer, however, is that the adhesion between adhesive layer and reflective layer is greater than between the adhesion-reducing layer/embossing varnish layer and the reflective layer-only in this way does it become possible to separate off the effect pigments on application of the vertical tensile force. The parting process of these water-soluble adhesives is then through the contacting of the acceptor foil with aqueous media.

Given that not all water-soluble compounds having the above-stated adhesion properties are sufficiently activatable thermally, it may be advantageous to print a very thin layer (dry <0.5 μm) of an adhesive over the full area of the reflective layer and only then to laminate the donor foil together with the acceptor foil. Suitable adhesives are starch-or dextrin-based adhesives, or polyethylene glycols. If the acceptor foil is print-pretreated, the spectrum of suitable adhesive layers for the lamination becomes wider.

If the adhesive layer is detached, the binder which is washed out of the adhesive layer and also the solvent can remain in the pigment concentrate in which the effect pigments are washed off. The effect pigments have a length and a width of between 4 μm and 40 μm and a thickness of between 2 nm and 1350 nm. Accordingly, the effect pigments generated in the method of the invention have a better resolution than that achievable in conventional printing methods.

With particular preference, the method may be performed in-line. This means that the donor foil and the acceptor foil are embodied as a web element-that is, as a foil band on a foil web. In the production process, the acceptor foil and the donor foil are then unwound continuously from a roll, and all of the method steps are carried out in succession on the foil web in a single operation.

In one preferred embodiment, in the case of dissolution of the adhesive layer on detachment of the effect pigments, the acceptor foil can be used again, by simple application of an adhesive layer anew to the acceptor foil.

The method described will now be described with reference to an exemplary embodiment. On the acceptor foil, made of PET, for example, a vinyl chloride copolymer, such as Vinnol H15/45M, for example, is used as adhesive layer and is physically dried-it contains a carboxyl group to improve the metal adhesion. The reflective layer disposed on the donor foil is subsequently laminated at 140 °C to the adhesive layer of the acceptor foil, without use of an additional adhesive formulation. The laminating temperature may be lowered by addition of plasticizers, such as Palatinol N or Palatinol DINCH, for example. In addition, it may be necessary to stabilize the binder with respect to thermal degradation. Suitable for this purpose are all known PVC stabilizers and combinations of these.

At any point in time after the laminate has cooled, it undergoes separative winding, where a tensile force is applied to the laminate. In this operation, the only parts of the reflective layer transferred to the adhesive layer are those which were previously disposed on the plateau areas of the relief structure. Further forms of structuring, such as embossed designs (inner contours), of these plateau areas are imaged in the adhesive layer.

The physical stability of the effect pigments in the subsequent steps is dependent on their thickness, meaning that different subsequent steps may be necessary, depending on thickness, to produce a pigment ink.

In this exemplary embodiment, the effect pigments are parted from the acceptor foil with a suitable solvent, such as MEK, for example, together with the adhesive layer. By centrifuging and/or filtering, the effect pigments are subsequently enriched and the binder content is lowered by washing processes. If the reflective layer contains a magnetic sublayer, it may be advantageous for the effect pigments not to be dried completely at any point in time. This prevents agglomeration of the effect pigments, which makes separation of the effect pigments more difficult. If drying is omitted, the effect pigments have a solvent shell and do not clump together so severely. In the case of magnetic effect pigments, operations should as far as possible also take place free from magnetic fields, again in order to prevent agglomeration of the effect pigments.

Because the effect pigments are metal-based pigments, the effect pigments may need to be stabilized by silanization, which can be carried out according to known methods.

### Variant 2

The second variant of the method is modified in terms of the arrangement of the layers. A donor foil and an acceptor foil, composed for example of PET, are provided.

Applied to one side of the donor foil, over the full area, is an adhesion-reducing layer. As already described in the first variant, the adhesion-reducing layer may comprise a washable ink or a thin release layer with which additives are applied. The reflective layer, in all possible embodiments as have already been described, is subsequently applied over the full area to this adhesion-reducing layer in a PVD method. The low thickness of the reflective layer ensures that, despite the absence of predetermined breakage points in this variant, the reflective layer breaks in a contour-precise way, without damage to the effect pigments or the generation of an unwanted size distribution. The adhesion of the reflective layer to the adhesion-reducing layer must not be too strong, in order to allow the reflective layer to be detached; however, it must also not be too low, since otherwise the effect pigments cannot be parted with edge definition with a clearly predetermined contour. In the simplest case, the reflective layer present is only an aluminium layer, since then breaking occurs with edge definition by virtue of the low layer thickness of down to 2 nm.

Subsequently, the adhesive layer is applied. For this, in the second variant, three potential pathways are employed.

In a first pathway, a relief structure is located on the acceptor foil and is shaped with plateau areas, flanks and lowered regions. The adhesive layer is then applied over the full area to the relief structure. The relief structure is preferably shaped in an embossing varnish layer.

In a second pathway, the acceptor foil likewise has the relief structure. However, the adhesive layer is not applied, as before, to the relief structure of the acceptor foil, but is instead applied over the full area to the reflective layer on the donor foil. In this case, it is essential to select an adhesive layer which breaks easily in the further course of the method, since in this variant not only the reflective layer, but also the adhesive layer located thereon, must break with edge definition. Acrylates, for example, may be used as the adhesive layer. Breaking of the adhesive layer with edge definition is anticipated when the glass transition temperature Tg lies above the temperature at which separative winding is performed. The adhesive used may comprise aqueous dispersions which do not, or only barely, reach their minimum film-forming temperature (MFFT) after application, in the course of drying. In that case, the polymer particles of the adhesive layer are indeed applied, but do not form a film. Only during the adhesive bonding process, at relatively high temperature, do the polymer particles then form a film in the bondline (heating from the acceptor foil). The breaking of a film is therefore not required.

In a third pathway, there is a relief structure neither on the donor foil nor on the acceptor foil, and the adhesive layer itself is applied with structuring, in a PL micro-gravure process, for example. The shape in which the adhesive layer is applied then corresponds to the shape of the subsequent effect pigments.

Subsequently, as in the first variant, a laminate is generated in the second variant, too, composed of the donor foil and the acceptor foil. Here, the adhesive layer of the acceptor foil is laminated to the reflective layer of the donor foil. In the next step, the donor foil is parted from the acceptor foil again, by the application to the laminate of a vertical tensile force, with the reflective layer being separated off in pieces from the laminate and remaining on the acceptor foil.

In the second pathway, the reflective layer is in contact with the adhesive layer only in the plateau areas, and so the pieces break off from the reflective layer, correspondingly, in the form of the plateau areas-they are parted from the donor foil, as the latter has been given an adhesion-reducing pretreatment. While no predetermined breakage points are provided in the reflective layer, the adhesion-reducing pretreatment nevertheless enables breaking with edge definition, to generate a clear contour.

In the second pathway, the adhesive layer joins to the acceptor foil likewise only in the plateau areas, and yet the adhesive layer is applied over the full area and therefore must likewise be broken when the vertical tensile force is applied. A key criterion in this respect is the internal strength of the adhesive layer. The materials described above can be used for the adhesive layer.

In the third pathway, the adhesive layer has a structured rather than a full-area configuration, and so the parts of the reflective layer that are in contact with the structured adhesive layer are separated off as pieces with a clear contour after the laminating and separating.

In the last step of the method, the pieces are parted as effect pigments from the acceptor foil. The outer contour of the pieces is predetermined by the prior structuring of the reflective layer, and they can be detached in turn without substantial mechanical assistance, by dissolving or loosening of the adhesive layer or by infiltration of the pieces. With particular preference, the pieces are detached without any further mechanical assistance.

The invention is elucidated in more detail below by means of exemplary embodiments with reference to the appended drawings, which likewise disclose features essential to the invention. These exemplary embodiments serve merely for illustration and should not be interpreted as imposing limitation. For example, a description of an exemplary embodiment with a multiplicity of elements or components should not be interpreted to mean that all of these elements or components are necessary for the implementation. Instead, other exemplary embodiments may also comprise alternative elements and components, fewer elements or components, or additional elements or components. Elements or components of different exemplary embodiments may be combined with one another, unless the contrary is indicated. Modifications and derivations which are described for one of the exemplary embodiments may also be applicable to other exemplary embodiments. In order to avoid repetition, identical or mutually corresponding elements in different figures are given the same reference symbols and not elucidated multiply. In the figures:

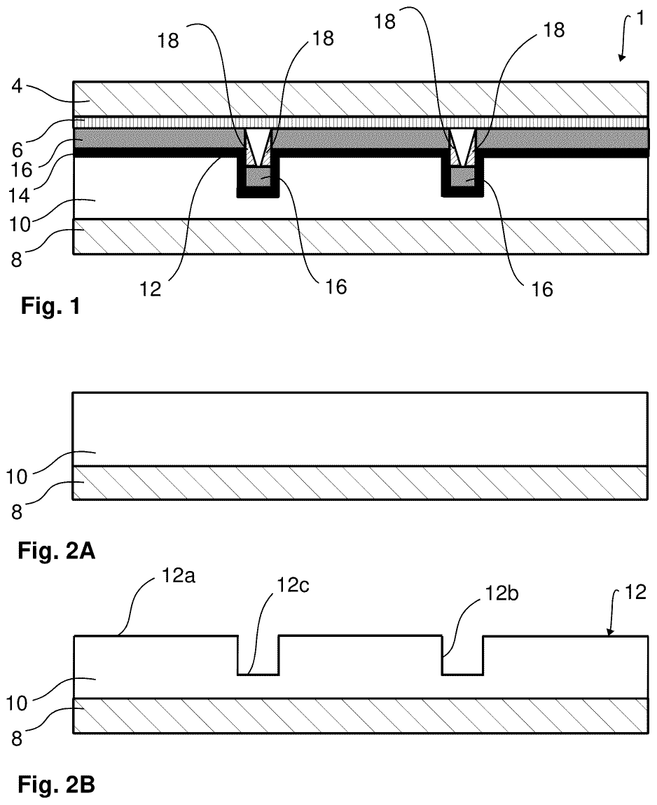

FIG. 1 shows a first laminate for the generation of effect pigments;

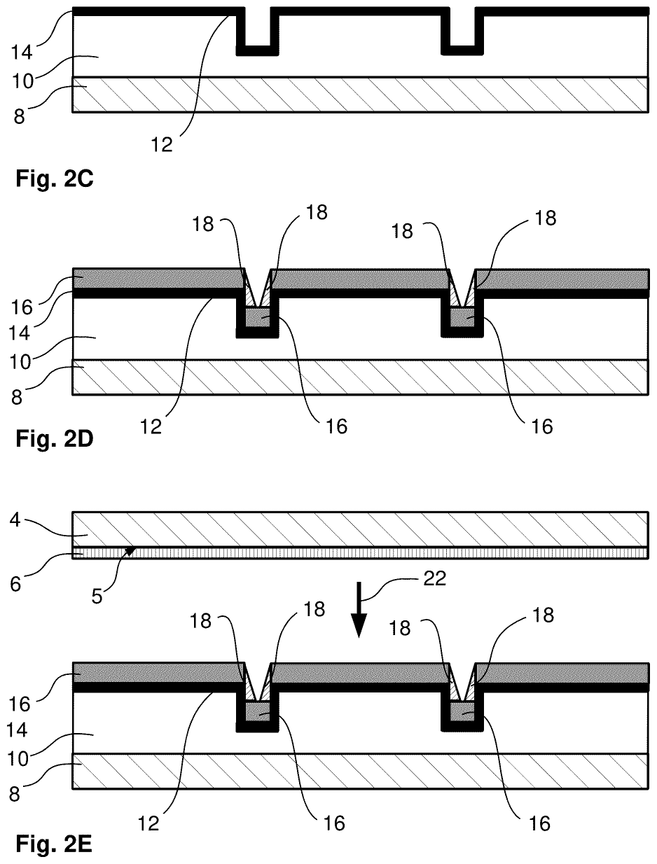

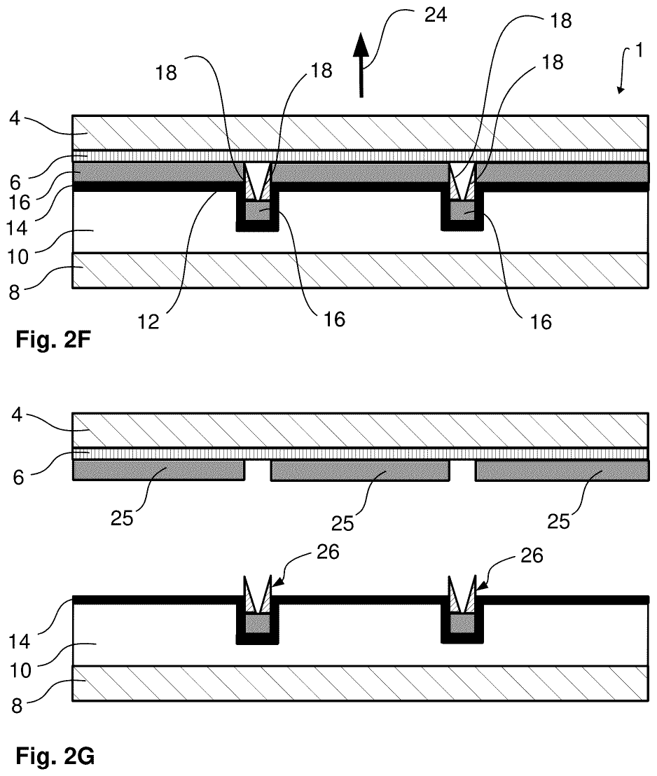

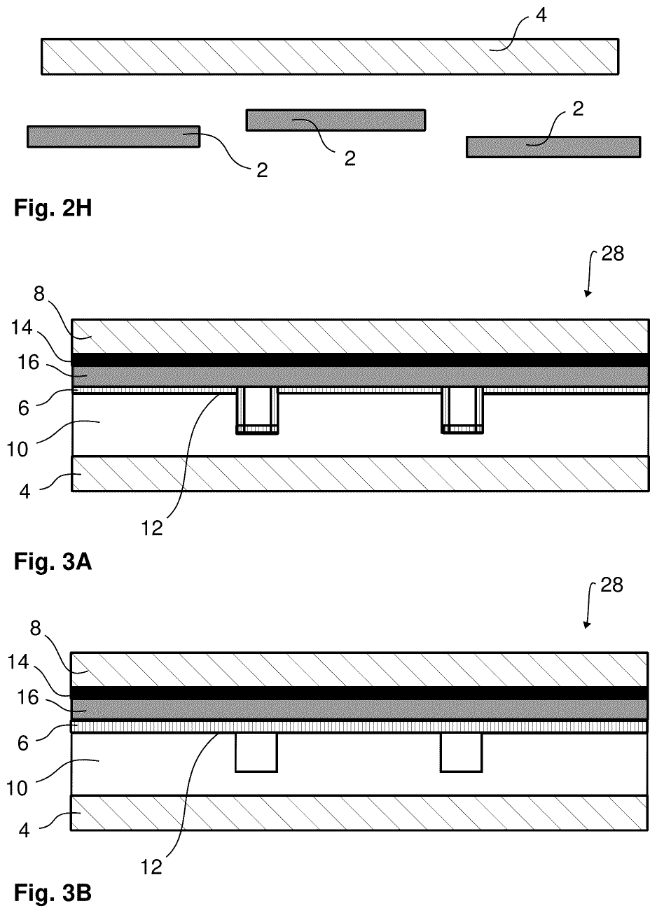

FIG. 2A to FIG. 2H show individual steps in the generation of effect pigments.

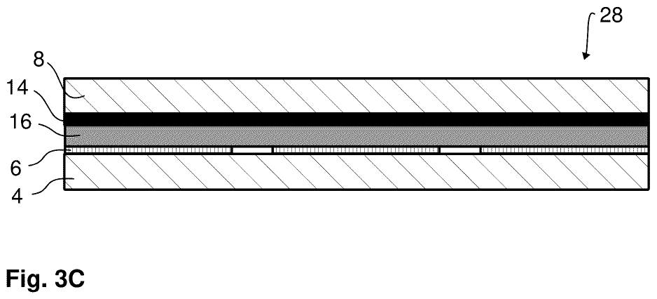

FIGS. 3A to 3C show different variants of a second laminate for the generation of effect pigments.

Structures which correspond to one another structurally or functionally are each provided with the same reference symbol in the figures.

FIG. 1 shows a first laminate 1, which is generated in the method of the invention for generating effect pigments 2. Applied over the full area of an acceptor foil 4 is an adhesive layer 6. The adhesive layer 6 is laminated to the layers provided on a donor foil 8. In detail, the donor foil 8 bears an embossing varnish layer 10 which is structured with a relief structure 12. An adhesion-reducing layer 14 is applied on the relief structure 12 in the embossing varnish layer 10. Directly above the adhesion-reducing layer 14, a reflective layer 16 is applied. It is applied over the full area of the adhesion-reducing layer 14, but thins at the flanks of the relief structure 12, so generating predetermined breakage points 18 in the reflective layer 16. In exemplary embodiments (not explicitly represented), the adhesion-reducing layer 14 may also be omitted.

According to FIG. 1, in the method for producing effect pigments 2, the first laminate 1 is formed and subsequently parted again in a plurality of steps. The individual method steps are elucidated step by step below, with reference to FIGS. 2A to 2H.

FIG. 2A shows a first step, in which the donor foil 8, with the embossing varnish layer 10 disposed on its facing side 20, is provided, before the embossing varnish layer 10 is structured in a second step. The layer may be structured via embossing, or alternatively by lasering or etching—in the embossing varnish layer 10 on the donor foil 8, the relief structure 12 with plateau areas 12a, flanks 12b and lowered regions 12c is formed, as is shown in FIG. 2B.

The configuration of the relief structure 12, particularly of its plateau areas 12a, is significant because the outline of the plateau areas 12a defines the contour of the subsequent effect pigments 2. Though not explicitly represented, the plateau areas 12a may also be structured in such a way that there are further lowered regions 12c within a plateau area 12a—in the subsequent effect pigment 2, they define an inner contour. With regard to the structuring of the plateau areas, there are no limits on the imagination; they may represent any kind of shapes, symbols or even text. The inner contours too may be configured in these ways.

Though not explicitly represented, but of course likewise possible, the plateau areas 12a in the relief structure 12 may have different configurations-in that case, of course, differently configured effect pigments 2 are also formed at the end of the method, albeit in a single procedure.

In a third step, the relief structure 12 is given an adhesion-reducing pretreatment. The product of this third step is represented in FIG. 2C. The adhesion-reducing pretreatment may take place in a variety of ways.

In embodiments, an adhesion-reducing coating 14 is applied to the relief structure 12, and may for example be a thin release layer with which additives are applied in highly diluted form to the relief structure 12—generally in a printing process. After a UV curing process, the embossing varnish layer 10 is normally present with an active surface. The additives ensure inactivation of the surface of the embossing varnish layer 10, either by reducing the surface tension of the embossing varnish layer 10 or migrating to the surface of the embossing varnish layer 10.

A washable ink may likewise be applied in a printing process as an adhesion-reducing layer 14. In that case, the active surface of the embossing varnish layer 10 is temporarily overprinted and inactivated by subsequent washing. This produces a reduction in adhesion without an apparent additional intermediate layer. It is of course likewise possible for these two variants to be combined for the application of the adhesion-reducing coating 14.

In the simplest case (although not explicitly represented), no adhesion-reducing coating 14 is necessary—in this case, the embossing varnish layer 10 itself exhibits adhesion-reducing properties, and adhesion-promoting method steps between relief structure 12 and reflective layer 16 are omitted entirely.

In a fourth step, the reflective layer 16 is applied over the full area of the relief structure 12 in the embossing varnish layer 10. The result of the fourth step is represented in FIG. 2D. Located between the embossing varnish layer 10 and the reflective layer 16 is the adhesion-reducing layer 14. The reflective layer 16 is applied via physical vapour deposition-this enables a particularly thin application of the layer over the full area. The reflective layer is located over the full area of the adhesion-reducing layer 14, but is deposited more thinly at the flanks 12b of the relief structure 12 than on the plateau areas 12a and in the lowered regions 12c, with the result that predetermined breakage points 18 are formed in the reflective layer 16 at the flanks 12b—they represent deliberately generated weak points in the full-area-applied reflective layer 16. As already explained, the reflective layer 16 may be single-layer or multilayer. In the simplest case, the reflective layer 16 is a metal layer, composed of aluminium, copper, chromium, iron, nickel, cobalt or silver, for example. A reflective layer 16 of aluminium may have a particularly thin configuration-it may have layer thicknesses of down to 2 nm.

Multilayer applications, as described at length in the general part of the description, may likewise be applied. The configuration of the reflective layer 16 is governed by the properties intended for the subsequently generated effect pigment 2, since the only product of the production method is the reflective layer 16, as effect pigment 2.

In a fifth step, shown by FIG. 2E, the acceptor foil 4 is provided. The adhesive layer 6 is disposed on the facing side 5 of the acceptor foil. The acceptor foil 4 as well is preferably a PET foil. It is placed in vertical direction 22, by the adhesive layer 6 disposed on its facing side 5, onto the reflective layer 16 of the donor foil 8. As represented in FIG. 1, after placement onto the reflective layer 16, the adhesive layer 6 is in contact with the reflective layer 16 exclusively in the plateau areas 12a. The adhesive layer 6 is laminated at the plateau areas to the reflective layer 16. This produces the first laminate 1.

Subsequent to this laminating step, the donor foil 8 is separated again from the acceptor foil 4 in a sixth step, by the application to the first laminate 1 of a vertical tensile force 24, as is represented in FIG. 2F. The application of this vertical tensile force 24 causes the first laminate 1 to part again. Because of the adhesion-reducing layer 14, the adhesion between this particular layer and the reflective layer 16 is lower than between the reflective layer 16 and the adhesive layer 6 which are in contact with one another in the plateau areas 12a. As a result, on application of the vertical tensile force 24, the reflective layer 16 is parted from the plateau areas 12a—it remains adhering on the adhesive layer 6, in the form of the pieces 25. Because the reflective layer 16 is diluted at the predetermined breakage points 18, the reflective layer on detachment from the plateau areas 12a breaks at precisely these predetermined breakage points 18 and is therefore separated with a clear edge from a remaining, residual layer 26, which corresponds to the parts of the reflective layer 16 which were situated at the flanks 12b and in the lowered regions 12c of the relief structure 12. The clear contour of the pieces 25 and hence also of the subsequent effect pigments 2 is therefore ensured in three respects-firstly, the pieces 25 part from the plateau areas 12a very easily because of the adhesion-reducing layer 14; further, the predetermined breakage points 18 ensure the separation of the pieces 25 from the residual layer 26 at a clear edge; and, because the pieces 25 adhere on the adhesive layer 6 during separation from the residual layer 26, they are additionally protected from disintegrating or tearing. The first laminate 1 is separated as described: as elucidated, the results are the products represented in FIG. 2G.

In the further method, only the acceptor foil 4 is treated further, and so contamination of the effect pigments 2 by parts of the residual layer 26 is specifically avoided when the pieces 25 are parted.

In a seventh and last step of the method, the pieces 25 are detached from the adhesive layer 6. In the simplest case, the adhesive layer 6 is fully dissolved here-this is shown by FIG. 2H. Mechanical methods for assistance when detaching, such as brushes or winding over an edge, which carry the risk of damage to the pieces 25, are deliberately shunned, in order to improve the purity of the effect pigments 2. The parting of the effect pigments requires only a particularly gentle treatment with a felt, a washing bar, a wiping lip, or the like. With particular preference, this gentle treatment may also be omitted entirely. Detachment by infiltration of the pieces 25 would also be possible, alternatively; this too is carried out without substantial mechanical assistance. The adhesive layer 6, however, in that case no longer dissolves, but instead remains on the acceptor foil 4 (not explicitly represented).

FIGS. 3A to 3C show alternative variants of a second laminate 28. The second laminate is characterized in that the adhesion-reducing layer 14 is applied over the full area to the donor foil 8 and subsequently the reflective layer 16 is applied by vapour deposition, likewise over the full area. The acceptor foil 4 may either have no structuring, as represented in FIG. 3C, or may on one side have the embossing varnish layer 10 which is structured with the relief structure 12-the latter is shown in FIGS. 3A and 3B.

In all three variants, the effect pigments 2 are shaped with clear contours-even without the presence of predetermined breakage points 18, the contour-precise removal of the pieces 25 is ensured either by the structured application of the adhesive layer 6 or by the introduction of the relief structure 12 into the embossing varnish layer 10.

FIG. 3A shows the first variant of the second laminate 28. The relief structure 12 is modelled in the embossing varnish layer 10 which is located on the acceptor foil 4. When the donor foil 8 and the acceptor foil 4 are laminated to one another in vertical direction 22, then, in analogy to the first variant, the reflective layer 16 comes into contact with the adhesive layer 6 at the plateau areas 12a. In the alternative method as well, therefore, the reflective layer 16 is removed in these regions from the remaining portions as pieces 25, which correspond to the subsequent effect pigments 2. In order to be able to ensure removal at precisely determined contours even without the presence of predetermined breakage points 18, it is necessary in this alternative method for the reflective layer 16 selected to be correspondingly thin. The detachment of the pieces 25 then takes place as already elucidated, by breaking out at the plateau areas 12a.

In the variant shown in FIG. 3B, the second laminate 28 corresponds in terms of layer sequence to the second laminate 28 according to FIG. 3A, although the adhesive layer 6 is applied not to the acceptor foil 4 but instead to the donor foil 8, over the full area. The removal of the pieces 25 is then analogous, although it is necessary for not only the reflective layer 16 but also the adhesive layer 6 to be removed with contour precision-the material for the adhesive layer 6 should be selected correspondingly.

In the third variant of the second laminate 28, according to FIG. 3C, the acceptor foil has no structuring-no embossing varnish layer 10 is necessary. In this case, the adhesive layer 6 is applied with structuring in the form of the subsequent effect pigments 2—in this case as well, the pieces 25 are removed with contour precision from the acceptor foil 4 when the donor foil 8 is separated, after lamination.

### LIST OF REFERENCE SYMBOLS

1 first laminate
2 effect pigment
4 acceptor foil
5 facing side of acceptor foil
6 adhesive layer
8 donor foil
10 embossing varnish layer
12 relief structure
12a plateau areas
12b flanks
12c lowered regions
14 adhesion-reducing layer
16 reflective layer
18 predetermined breakage points
20 facing side of donor foil
22 vertical direction
24 vertical tensile force
25 piece
26 residual layer
28 second laminate

1-12. (canceled)

13. A method for producing effect pigments, comprising the steps of:
providing a donor foil,
forming a relief structure having plateau areas, lowered regions and in-between flanks,
applying a reflective layer to the plateau areas, lowered regions and in-between flanks of the relief structure,
providing an acceptor foil with an adhesive layer disposed thereon,
generating a first laminate composed of the donor foil and the acceptor foil, with the adhesive layer of the acceptor foil being laminated to the reflective layer of the donor foil on the plateau areas,
peeling the donor foil from the acceptor foil, with the reflective layer remaining as a residual layer in the lowered regions and the flanks of the relief structure on the donor foil, and the adhesive layer and the reflective layer disposed beforehand on the plateau areas remaining on the acceptor foil and forming there a multiplicity of individual pieces, and
detaching the pieces as effect pigments from the acceptor foil, with an outer contour of the effect pigments being predetermined by the shape of the plateau areas,
wherein the relief structure is given an adhesion-reducing pretreatment before the reflective layer is applied, and
the detaching of the pieces as effect pigments from the acceptor foil comprises detaching or loosening the adhesive layer or infiltrating the pieces with a release agent, with the
adhesive layer remaining on the acceptor foil.

14. The method for producing effect pigments, comprising the steps of:
providing a donor foil and an acceptor foil,
applying a reflective layer over the full area to the donor foil,
applying an adhesive layer to the reflective layer or to the acceptor foil, where
either the adhesive layer is applied with structuring to the donor foil or the acceptor foil,
or a relief structure with plateau areas, lowered regions and in-between flanks is shaped on the acceptor foil, and the adhesive layer is applied without structuring to the donor foil or to the relief structure of the acceptor foil,
generating a second laminate composed of the donor foil and the acceptor foil, with the donor foil and the acceptor foil being laminated to one another by way of the adhesive layer of the acceptor foil,
peeling the donor foil from the acceptor foil, with the reflective layer remaining in the form of a multiplicity of pieces on the acceptor foil, and
detaching the piece as effect pigments from the acceptor foil, with an outer contour of the effect pigments being predetermined either by the structuring of the adhesive layer or by the shape of the plateau areas,
wherein the donor foil is given an adhesion-reducing pretreatment before the reflective layer is applied, and
the detaching of the pieces as effect pigments from the acceptor foil comprises detaching or loosening the adhesive layer or infiltrating the pieces with a release agent, with the adhesive layer remaining on the acceptor foil.

15. The method according to claim 13, wherein the adhesion-reducing pretreatment comprises printing with a washable ink and washing off the washable ink again.

16. The method according to claim 15, wherein the washable ink after physical drying thereof is washed off in a separate operation which takes place before the reflective layer is applied.

17. The method according to claim 13, wherein the relief structure is shaped in an embossing varnish layer.

18. The method according to claim 17, wherein in at the adhesion-reducing pretreatment of the embossing varnish layer is accomplished by adding additives which reduce the surface tension of the embossing varnish layer.

19. The method according to claim 13, wherein the reflective layer is adapted to the material forming the relief structure in such a way that the adhesion between relief structure and the reflective layer is lower than the adhesion between the adhesive layer and the reflective layer.

20. The method according to claim 13, wherein the reflective layer comprises a PVD laminate.

21. The method according to claim 20, wherein the lowermost layer of the PVD laminate is adapted to the relief structure in such a way that the adhesion between the relief structure and the lowermost layer of the PVD laminate is lower than the adhesion between adhesive layer and the uppermost layer of the PVD laminate.

22. The method according to claim 13, wherein the reflective layer perpendicularly to the flank area is applied more thinly at the flanks than on the plateau areas, and so regions thinned out at the flanks are generated as predetermined breakage points in the reflective layer, and/or in that the reflective layer is applied more thinly at convex bends of the relief structure than on the plateau areas, and so regions thinned out at the bends are generated as predetermined breakage points in the reflective layer.

23. The method according to claim 13, wherein the effect pigments have a mandated inner contour which is predetermined by the configuration of the plateau areas.

24. The method according to claim 13, wherein the pieces are detached without brushing or winding around an edge.
